(19) United States
(12) Patent Application Publication
(10) Pub. No.: US 2024/0013952 A1
(43) Pub. Date: Jan. 11, 2024

(54) WIRE PROCESSING DEVICE

(71) Applicant: SW AUTOMATISIERUNG GMBH, Golling an der Salzach (AT)

(72) Inventor: Johannes SCHAUER, Kuchl (AT)

(21) Appl. No.: 18/217,673

(22) Filed: Jul. 3, 2023

(30) Foreign Application Priority Data
Jul. 11, 2022 (AT) A 50505/2022

(51) Int. Cl. H01B 13/00

(52) U.S. Cl. CPC H01B 13/0003

(57) ABSTRACT

A wire processing device including a wire processing mechanism for processing a wire, and a wire handling device for transferring the wire to the wire processing mechanism. The wire processing device has a carrying device, and a holding device for holding the at least one wire can be releasably arranged on the carrying device. The wire processing device includes an acquisition device for acquiring data stored on the holding device.

### BACKGROUND OF THE INVENTION

The present invention relates to a wire processing device, in particular a wire finishing machine, and a wire processing system with such a wire processing device.

Within the framework of the present disclosure, the term wire comprises individual insulated or bare wires, single-core or multi-core wires or cables with sheathing, cable harnesses, stranded wires, fiber optic cables or the like. A wire section can be various elements. By the name wire section is meant for example multi-core or single-core wires or cables with sheathing, individual insulated or bare wires, cable harnesses, finished wiring looms, stranded wires, fiber optic cables or the like.

Wire processing devices, in particular wire finishing machines, are used to finish or pre-finish wires or wire sections. For this purpose, a wire processing device comprises at least one wire processing mechanism, in which a wire fed to the wire processing mechanism is finished or pre-finished. For example, the wire is cut to length, stripped, partially stripped and/or crimped with, pressed into, soldered to, glued to or shrink-wrapped with a wire termination (e.g. in the form of a ferrule, a cable lug or a flat connector, etc.). To transfer and feed the wire to the at least one wire processing mechanism, a wire processing device comprises a wire handling device, which can be formed for example as a gripper or robot arm.

The wire processing device is usually provided with several wires, e.g. with different wire thicknesses and/or differently colored sheathings, from wire stores. By wire store may be meant a wire container, for example also a drum-like container, in which a wire which has been wound, spooled, coiled or laid or deposited in any other manner is stored. In the case of conventional wire processing devices, wires from several wire stores are guided to the wire processing device and attached to a terminal block there, for example the wire ends of six wires from six wire stores are clamped next to each other on the terminal block. Depending on the wire to be processed, the wire handling device grips the corresponding wire, provided on the terminal block, and transfers it to the corresponding wire processing mechanism of the wire processing device for end processing.

Changing the wire population is associated with a high manipulation cost. If one or more of the wires provided is to be swapped with another wire (e.g. with a different wire thickness or with a different sheathing), the wire to be swapped out has to be released from the terminal block and the new wire has to be guided to the terminal block and attached thereto in place of the previous wire.

### SUMMARY OF THE INVENTION

The object of the invention is to specify a wire processing device that is improved compared with the state of the art. In particular, the manipulation cost for changing the wire population is to be reduced. Furthermore, a wire processing system with a wire processing device improved in such a way is to be specified.

In the wire processing device according to the invention, the wire processing device has at least one carrying device, wherein at least one holding device for holding the at least one wire can be releasably arranged on the at least one carrying device.

The manipulation cost for changing the wire population can be greatly reduced by replacing the fixed terminal block with a carrying device on which at least one holding device for holding the at least one wire can be releasably arranged. Namely, holding devices populated with the desired wires can already be prepared, with the result that, for example if it is desired to change the wire population, the holding device currently arranged on the carrying device is only to be swapped with an already prepared holding device, on which the desired wires are arranged and provided. Alternatively or additionally, a prepared holding device can also additionally be attached to the carrying device, with the result that the wire handling device also gains access to the new, desired wires. Overall, a shortened set-up time or changeover time for the wire processing device can thereby be achieved.

The wire processing device comprises at least one acquisition device for acquiring data stored on the at least one holding device.

Thus, the at least one holding device can comprise an encoder which contains data or in which data are stored. The encoder can be, for example, a barcode, binary coded switching cams, a data matrix code (e.g. QR code) or an RFID transponder for identifying the holding device. Here, a unique identification number of the holding device can be stored in the encoder, thus for example in the form of a barcode, switch state of the binary switching cams, data matrix code or RFID tag corresponding to the identification number. This identification number can be read by means of the acquisition device (by means of a reader, known per se, corresponding to the respective encoder) and transmitted to a control device of the wire processing device. Further data about the identified holding device, thus for example what wire population this holding device is provided with, can be recorded in the control device. This information can then be incorporated in a wire processing process running in an automated manner.

In relation to the encoder it is also possible that what wires are provided by the holding device are stored on a prepared holding device in the encoder. Thus, a holding device can comprise for example 12 holding mechanisms for one wire each and, after the holding device has been populated, up to 12 wires with different diameters or cross sections can thus be provided by the holding device. Usual wire diameters lie for example in a range of from approximately 1 mm to approximately 6 mm. Which of the 12 holding mechanisms is populated with what wire configuration can then be stored in the encoder of the prepared holding device, for example in a memory. These data can be read by the at least one acquisition device and transmitted to the control device of the wire processing device, with the result that this information can be incorporated in a wire processing process running in an automated manner. In this case, the encoder can be for example an RFID transponder, which comprises a memory, on which the corresponding data are stored. The acquisition device can be a reader for reading RFID transponders. The reading of the data can be effected by means of wireless protocols known per se, such as e.g. NFC.

According to a preferred embodiment, the at least one carrying device is arranged on the wire processing device movable relative to the wire handling device, preferably displaceable translationally back and forth along a movement direction. Several holding devices can thereby be arranged on the carrying device (e.g. next to each other or one behind another) and the holding device required in each case for a processing step can be moved into the handling area of the wire handling device by movement of the carrying device.

The wire processing device comprises at least one guide device, wherein the at least one carrying device is mounted on the at least one guide device movable translationally along the at least one guide device. Of course, other arrangements for moving the at least one carrying device, by which the at least one carrying device is for example rotated and/or pivoted, are also conceivable.

In a particularly preferred embodiment, the at least one carrying device has at least one connection device for connecting the at least one carrying device to the at least one holding device. The at least one connection device can comprise, for example, a profiled rail, onto which a holding device can be fitted in a positive-locking manner or which can be inserted into a recess of the holding device corresponding to the shape of the profiled rail. In particular, a toolless attachment of the at least one holding device to the at least one carrying device, and equally a toolless release of the at least one holding device from the at least one carrying device, can thereby be made possible.

Preferably, the wire processing device comprises a locking device for locking the at least one holding device on the at least one carrying device and for releasing the at least one holding device from the at least one carrying device. With the locking device, the at least one holding device can be locked stationary on the carrying device and also released again so that it can be removed from the carrying device again. The locking device can be for example a device known per se such as a clamping lever or a locking pin.

In a particularly preferred embodiment, at least two holding devices can be arranged on the at least one carrying device, preferably one behind another along a longitudinal extent of the at least one carrying device. This makes an even faster changeover of the wire processing device possible, as the next holding device to be used can already be arranged on the carrying device and there is no need to effect a swap of the holding devices first. The holding devices can be arranged on the at least one carrying device next to each other, one behind another, one above another or in any desired arrangement.

Preferably, the wire processing device comprises at least one holding device for holding the at least one wire, wherein the at least one holding device is releasably arranged on the at least one carrying device. The release of the at least one holding device from the at least one carrying device and the attachment of the at least one holding device to the at least one carrying device can preferably be effected toollessly.

According to a particularly preferred embodiment, the at least one holding device comprises an encoder, wherein preferably data can be and/or are stored in the encoder. As already stated above, the encoder can be for example a barcode, binary coded switching cams, a data matrix code (e.g. QR code) or an RFID transponder, wherein the respective encoder comprises a unique identification number of the holding device, which can be read by a corresponding acquisition device of the wire processing device. The identification number can be transmitted to a control device of the wire processing device by the acquisition device. Further data about the identified holding device, thus for example what wire population this holding device is provided with, can be recorded in the control device. This information can then be incorporated in a wire processing process running in an automated manner. The encoder can also be for example an RFID transponder, in the memory of which data about the wire population of the holding device are stored. These data can then be read by an acquisition device of the wire processing device and transmitted to a control device of the wire processing device, with the result that this information can be incorporated in a wire processing process running in an automated manner.

Preferably, the at least one holding device has at least one connection mechanism for connecting the at least one holding device to the carrying device. The connection mechanism can for example correspond to a connection device of the carrying device, in order to make a positive-locking connection of the connection mechanism of the holding device to the connection device of the carrying device possible. Thus, for example, the connection device of the carrying device can comprise one or more profiled rails, and the connection mechanism of the holding device can accordingly comprise corresponding recesses or channels, into which the profiled rails can be inserted. The holding device can thereby be attached to the carrying device guided along the profiled rails.

According to a preferred embodiment, the at least one holding device comprises at least one holding mechanism for holding the at least one wire. The at least one holding device preferably comprises one holding mechanism per wire that is to be provided by the holding device. One wire is provided for the wire handling device by each holding mechanism. Thus, for example, the at least one holding device comprises a plurality of holding mechanisms arranged next to each other and/or one above another.

Preferably, the at least one holding mechanism comprises at least one locking mechanism for locking and releasing the at least one wire. A wire can be fixed relative to the holding device and also freed again by the locking mechanism. The locking mechanism can be for example a spring-actuated clamping mechanism, in which a wire clamping is effected by the spring force of a spring acting on a clamping element, wherein the spring-actuated clamping element clamps the wire between clamping element and a stationary counter element. Due to the clamping element moving away against the spring force, the wire clamping can be released and the wire can thus be freed for further processing.

To actuate the locking mechanism, the wire processing device can comprise an actuation mechanism (e.g. a release mechanism for a spring-actuated clamping mechanism), connected to a control device of the wire processing device, which can be controlled by the control device, for example corresponding to a program sequence running in an automated manner. Thus, in a program-controlled manner, the individual wires to be processed can be released by action of the actuation mechanism on the corresponding locking mechanisms and transferred to the respective wire processing mechanisms by the wire handling device for further processing.

If there are several locking mechanisms present, at least one movable actuation mechanism can be provided which is moved in a program-controlled manner to the respective locking mechanism in order to actuate the locking mechanism. However, for each locking mechanism one actuation mechanism dedicated to the locking mechanism can in each case also be provided.

According to a particularly preferred embodiment, at least one tube guide is arranged between the at least one holding mechanism and at least one wire store, wherein the at least one holding mechanism is preferably connected to the at least one tube guide. A wire provided from a wire store can be guided to the holding mechanism inside a tube guide, protected from external influences.

Preferably, the at least one tube guide comprises a, preferably flexible, tube. Through the provision of a flexible tube, any desired line guides of the flexible line can be made possible.

Preferably, the tube has a friction-reducing coating, preferably a Teflon coating, on an inner surface of the tube. The feeding of the wire to the holding mechanism inside the tube guide is thereby made significantly easier, as only small friction forces work against the wire while it slides along the inner surface of the tube. The entire inner surface of the tube is preferably provided with a friction-reducing coating.

Protection is also sought for a wire processing system comprising a wire processing device according to one of the previously described embodiments, at least one storage device comprising at least one wire store for providing at least one wire, at least one holding device for holding the at least one wire, wherein the at least one wire of the at least one wire store is guided to the at least one holding device and held by the at least one holding device, wherein the at least one holding device can be or is releasably arranged on the at least one carrying device of the wire processing device.

Preferably, the at least one wire is guided between the wire store providing the at least one wire and the at least one holding device at least in sections inside a tube guide comprising a, preferably flexible, tube. An inner surface of the tube can preferably be provided with a friction-reducing coating, in particular a Teflon coating.

According to a preferred embodiment, the at least one holding device comprises an encoder, wherein data can be and/or are stored in the encoder, wherein the wire processing device comprises at least one acquisition device for acquiring data stored in the encoder.

For example, data about which wires are provided by the holding device can be stored in the encoder of the at least one holding device. Thus, a holding device can comprise for example several holding mechanisms for one wire each and, after the holding device has been populated, several wires with different diameters or cross sections can thus be provided by the holding device. Which of the holding mechanisms is populated with what wire configuration can then be stored in the encoder, for example in a memory. These data can be read by the at least one acquisition device and transmitted to a control device of the wire processing device, with the result that this information can be incorporated in a wire processing process running in an automated manner. The encoder can be an RFID transponder, which comprises a memory, on which the corresponding data are stored. The acquisition device can be a reader for reading RFID transponders. The reading of the data can be effected by means of wireless protocols known per se, such as e.g. NFC.

In the case of a proposed wire processing system, several storage devices can for example be provided. Each storage device can comprise a plurality of wire stores (e.g. in the form of wire drums or other wire containers), which are placed next to each other on a storage floor of the storage device. The wires of the wire stores of a storage device can in each case be guided to a holding device and be held there by the holding device, wherein the wires can be guided between the wire stores and the holding device inside tube guides. The holding device can comprise an encoder, in which data about the populating of the holding device with the wires of the wire stores are stored. The holding devices prepared in such a way can be releasably arranged on the respective storage device. If a wire processing of a wire is to be effected by means of a wire processing device, the holding device of the storage device that stocks the desired wire can be releasably connected to the at least one carrying device of the wire processing device. An acquisition device of the wire processing device can read the data stored in the encoder relating to the populating of the holding device, whereby an automated wire processing process can be supported. After completion of the wire processing operations relating to this holding device, the holding device can be released from the at least one carrying device and arranged on the storage device again.

Preferably, the at least one storage device is formed mobile. Thus, for example, wheels can be arranged on an underside of the storage device, with the result that the storage device can be moved if required. The wheels can be arranged pivotable about vertical axes and be equipped with a fixing device in order to be able to move the storage device in any desired directions and fix it in the desired location.

### BRIEF DESCRIPTION OF THE DRAWINGS

Further details and advantages of the present invention are explained with the aid of the following description of the figures, in which:

FIG. 1 shows a wire processing device in a schematic representation according to the state of the art,

FIG. 2 shows an embodiment of a proposed wire processing device in a schematic representation,

FIG. 3 shows a further embodiment of a proposed wire processing device in a schematic representation,

FIG. 4 shows a further embodiment of a proposed wire processing device in a schematic representation,

FIG. 5 shows an embodiment of a proposed wire processing system in a schematic representation,

FIG. 6 shows a holding device according to FIG. 5 in an enlarged view,

FIG. 7 shows a further embodiment of a proposed wire processing system in a perspective view, and

FIG. 8 shows a detail representation from FIG. 7 in an enlarged view.

### DETAILED DESCRIPTION OF THE INVENTION

FIG. 1 shows a wire processing device 1 in a schematic representation according to the state of the art. The wire processing device 1 shown is a wire finishing machine which comprises a wire processing mechanism 2 for processing a wire 3. For this purpose, several wires 3 are provided on a terminal block 21 arranged stationary on the wire processing device 1. A wire 3 to be processed is guided by a wire handling device 4 from the terminal block 21 to the wire processing mechanism 2.

The wires 3 provided originate from a storage device 20 comprising several wire stores 16, for example in the form of wire drums or other wire containers, in which a respective wire 3 is present e.g. in wound form. The individual wires 3 from the respective wire stores 16 are guided further to the terminal block 21 locally brought together via a collection mechanism 22 on the storage device 20. The storage device 20 can be a free holding area or for example also be formed like shelves and is arranged locally spaced apart next to the wire processing device 1.

The terminal block 21 clamps the individual wires 3. The respectively required wire 3, which is to be passed on to the wire processing mechanism 2, is freed from the terminal block 21 and can be passed on to the wire processing mechanism 2 by the wire handling device 4. The clamping or freeing of the individual wires 3 in the terminal block 21 can be carried out mechanically, electrically, pneumatically or also hydraulically and is preferably controlled by a control device of the wire processing device 1, which is not represented here.

If the quantity of the wire 3 in a wire store 16 is coming to an end, the wire store 16 can be replaced—the wire 3 located therein is threaded through the collection device 22 and passed on to the terminal block 21 for further removal.

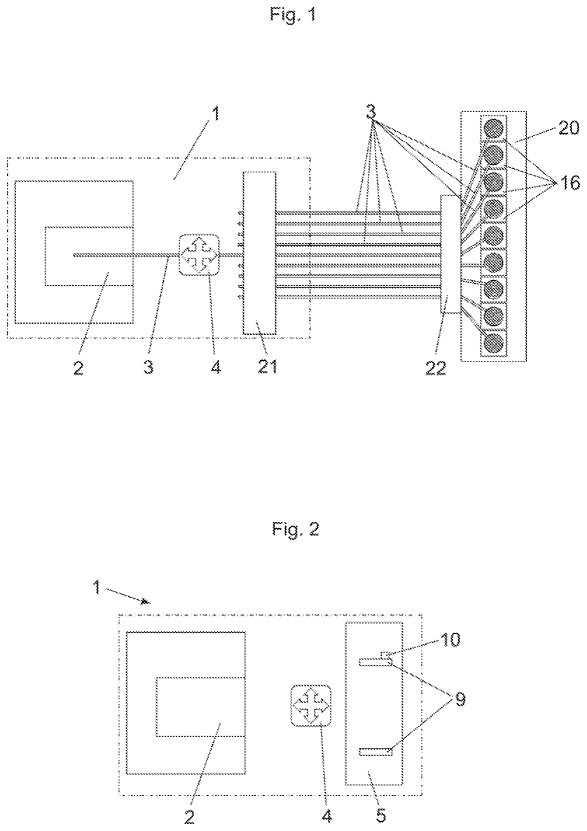

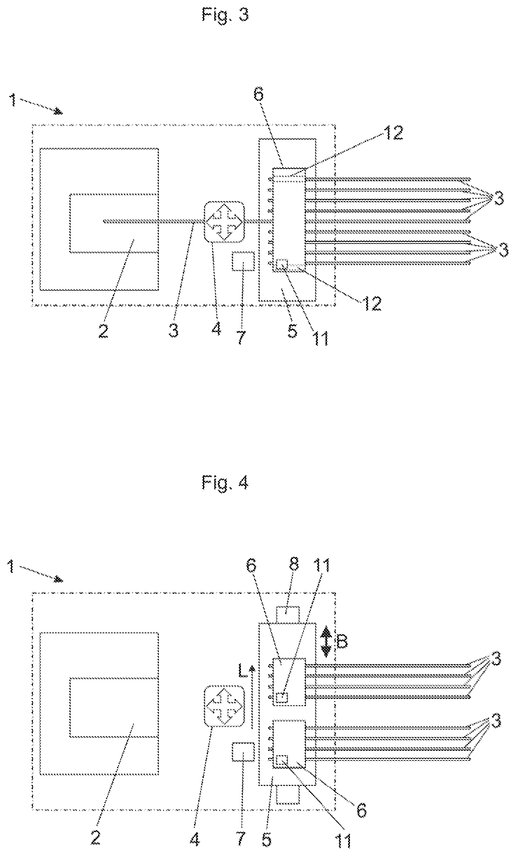

FIG. 2 shows an embodiment of a proposed wire processing device 1 in a schematic representation. In order to reduce the manipulation cost for changing the wire population compared with previous wire processing devices 1, the proposed wire processing device 1 comprises a carrying device 5, on which at least one holding device 6 (see e.g. FIG. 3 to FIG. 8) for holding the at least one wire 3 can be releasably arranged. Here, the wires 3 to be processed no longer need to be guided to a terminal block 21 arranged directly stationary on the wire processing device 1 and attached there, but rather a holding device 6 can be populated with the desired wires 3 and the holding device 6 prepared in such a way can be releasably arranged as a unit on the carrying device 5 of the wire processing device 1 and equally easily removed again. In particular, the attachment of the holding device 6 to the carrying device 5 and the release of a holding device 6 arranged on the carrying device 5 can be effected toollessly and thus particularly easily and quickly.

To connect the carrying device 5 to a holding device 6, the carrying device 5 has connection devices 9. In the example shown, the connection devices 9 comprise two profiled rails which are arranged spaced apart from each other and onto which a holding device 6 can be fitted in a positive-locking manner, for example by bringing connection mechanisms 12, formed corresponding to the profiled rails, on the holding device 6 into engagement with the profiled rails (see e.g. FIG. 3).

To lock a holding device 6 arranged on the carrying device 5 and to release a holding device 6 arranged on the carrying device 5 from the carrying device 5, the wire processing device 1 shown comprises a locking device 10, which is arranged on the carrying device 5 here in the area of one of the connection devices 9. With the locking device 10, a holding device 6 fitted onto the carrying device 5 can be locked stationary on the carrying device 5 and also released again so that it can be removed from the carrying device 5 again. The locking device can be for example a device known per se such as a clamping lever or a locking pin.

FIG. 3 shows a further embodiment of a proposed wire processing device 1 in a schematic representation. The wire processing device 1 shown here corresponds to the wire processing device 1 shown in FIG. 2, on the carrying device 5 of which a holding device 6 in the form of a wire cassette for nine wires 3 is releasably arranged. On its underside the holding device 6 comprises two connection mechanisms 12—indicated dashed here—for connecting the holding device 6 to the carrying device 5. The holding device 6 was populated with nine wires 3 and arranged on the carrying device 5 by being pushed onto the connection devices 9 with the connection mechanisms 12 which correspond to the connection devices 9 of the carrying device in terms of design. The holding device 6 was then locked relative to the carrying device 5 by means of a locking device not visible in this view, of the wire processing device 1.

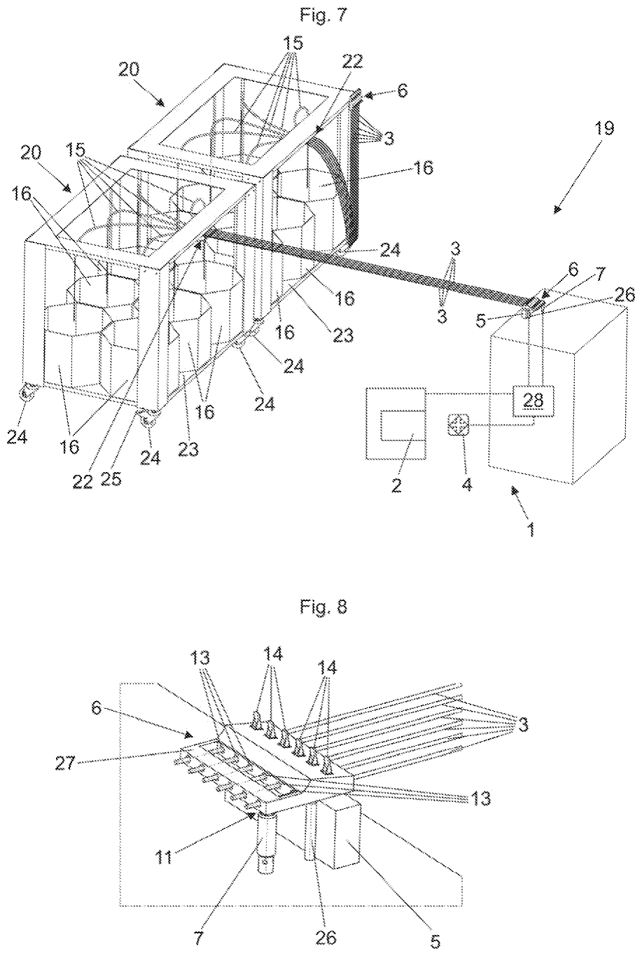

The holding device 6 represented here comprises an encoder 11 in the form of an RFID transponder, in the memory of which data relating to the wire population of the holding device 6 are stored. To read the data stored in the encoder 11 of the holding device 6, the wire processing device 1 comprises an acquisition device 7 in the form of an RFID read head. The latter can read the stored data and transmit them to a control device 28 of the wire processing device 1 (see e.g. FIG. 7), with the result that the read information can be incorporated in a wire processing process running in an automated manner. In the illustration represented, one of the wires 3 provided by the holding device 6 has been taken by the wire handling device 4 and transferred to the wire processing mechanism 2 for end processing of the wire 3.

FIG. 4 shows a further embodiment of a proposed wire processing device 1 in a schematic representation. The wire processing device 1 shown here comprises a carrying device 5, which is arranged on the wire processing device 1 movable relative to the wire handling device 4. Specifically, the carrying device 5 is displaceable translationally back and forth along a movement direction B. For this purpose, the wire processing device 1 comprises a guide device 8. The carrying device 5 is mounted on the guide device 8 movable translationally along the guide device 8. The carrying device 5 has a longitudinal extent L. Two holding devices 6 are arranged on the carrying device 5 one behind the other along the longitudinal extent L of the carrying device 5. Through the movability of the carrying device 5 along the movement direction B, the wires 3 of both holding devices 6 arranged on the carrying device 5 can be brought into the effective range of the wire handling device 4. The respective wire population of the two holding devices 6 is stored in encoders 11 of the holding devices 6 and can be read by an acquisition device 7 of the wire processing device 1.

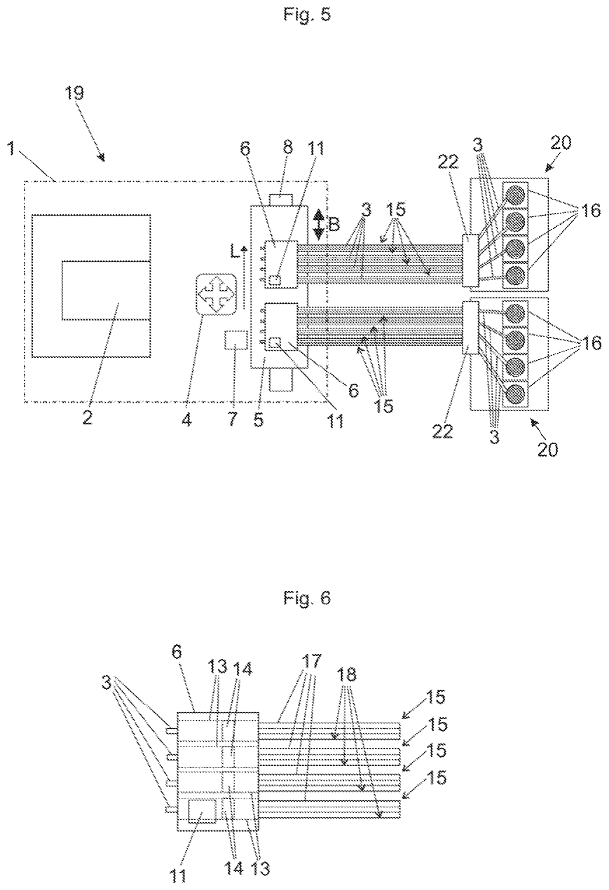

FIG. 5 shows an embodiment of a proposed wire processing system 19 in a schematic representation. The wire processing system 19 shown comprises a wire processing device 1 which is formed according to the wire processing device 1 of FIG. 4.

The wire processing system 19 moreover comprises two storage devices 20. The two storage devices 20 comprise in each case four wire stores 16 in the form of wire drums. Each wire store 16 provides a wire 3 with a particular diameter and with a particular sheathing. The wires 3 of the wire stores 16 of a storage device 20 are guided to a collection mechanism 22 on the storage device 20, in which they are brought together locally and starting from which they are guided further to a respective holding device 6. The wires 3 of the wire stores 16 of a storage device 20 are thus guided to a holding device 6 and are held by the holding device 6. The two populated holding devices 6 are releasably arranged on the carrying device 5 of the wire processing device 1. The wires 3 are guided between the collection mechanism 22 and the holding device 6 inside tube guides 15. The tube guides 15 protect the wires 3 from external influences.

FIG. 6 shows a holding device 6 according to FIG. 5 in an enlarged view. The holding device 6 comprises four holding mechanisms 13, arranged next to each other or one behind another in a longitudinal extent direction of the holding device 6, for holding one wire 3 in each case. The holding mechanisms 13 can be formed for example as channel-like openings, into which one wire 3 can be inserted in each case. Wire ends of the wires 3 protrude beyond the holding device 6, with the result that the wire ends can be easily gripped by the wire handling device 4.

To lock and release the wires 3, the holding mechanisms 13 in each case comprise a locking mechanism 14. The wires 3 can be fixed relative to the holding device 6 and also freed again by means of the locking mechanisms 14. The locking mechanisms 14 can be for example spring-actuated clamping mechanisms, in which a wire clamping is effected in each case by the spring force of a spring acting on a clamping element, wherein the spring-actuated clamping element clamps the respective wire 3 between clamping element and a stationary counter element. Due to the clamping element moving away against the spring force, the wire clamping can be released and the wire 3 can thus be freed for further processing. Data about the wire population of the holding device 6 are stored in an encoder 11, which is arranged on the holding device 6.

Each of the four holding mechanisms 13 is connected to a tube guide 15, which is arranged between the holding mechanism 13 and the wire store 16 providing the wire 3. In other words, the end of each tube guide 15 opens into one of the holding mechanisms 13, with the result that a respective wire 3 is guided directly into the holding mechanism 13 by the tube guide 15. A tube guide 15 in each case comprises a flexible tube 17, which has a friction-reducing coating, preferably a Teflon coating, on an inner surface 18 of the tube 17. The feeding of the wire 3 to the holding mechanism 13 inside the tube guide 15 is thereby made significantly easier, as only small friction forces work against the wire 3 while it slides along the inner surface 18 of the tube 17.

FIG. 7 shows a further embodiment of a proposed wire processing system 19 in a perspective view, and FIG. 8 shows a detail representation from FIG. 7 in an enlarged view.

The wire processing system 19 comprises one wire processing device 1 and two storage devices 20. For improved clarity, wire processing mechanism 2, wire handling device 4 and a control device 28 of the wire processing device 1 are only represented schematically. To make a program-controlled wire processing process possible, the wire processing mechanism 2, the wire handling device 4, an acquisition device 7 and an actuation mechanism 26 are signal-connected (e.g. via wired or wireless signal lines) to the control device 28 (these communication connections are indicated dashed).

The two storage devices 20 are formed mobile, by wheels 24 being arranged on the undersides of the storage devices 20. The wheels 24 are arranged on the storage devices 20 pivotable about vertical axes, in order to be able to move the storage devices 20 in any desired directions. In each case at least one wheel 24 of a storage device 20 is equipped with a fixing device 25 in the form of a wheel brake known per se, in order to be able to fix the storage devices 20 in the desired location.

Each storage device 20 comprises in each case six wire stores 16 in the form of wire drums, which are placed on a respective storage floor 23 of the storage device 20. Each wire store 16 provides a wire 3 with a particular diameter and with a particular sheathing. The wires 3 of the wire stores 16 of a storage device 20 are guided to a collection mechanism 22 (e.g. wire guides arranged next to each other), not visible in more detail in this view, on the storage device 20, in which they are brought together locally and starting from which they are guided further to a respective holding device 6. A wire diversion in the form of a tube guide 15 is arranged between a respective wire store 16 and the collection mechanism 22. The wires 3 are guided to the collection mechanism 22 by the tube guides 15, and from there the wires 3 run further to a holding device 6.

The holding device 6 of one of the two storage devices 20 represented is, for the time being, releasably attached to the storage device 20 itself and thus in standby position. The holding device 6 of the other storage device 20 represented is releasably arranged on the carrying device 5 of the wire processing device 1.

FIG. 8 shows the holding device 6 arranged on the carrying device 5 of the wire processing device 1 in an enlarged representation and from a different perspective compared with FIG. 7. To hold the wires 3, the holding device 6 comprises one holding mechanism 13 per wire 3. Each holding mechanism 13 comprises a wire channel, through which a respective wire 3 is guided. The holding device 6 shown here comprises an upstream frame 27, through which a respective wire channel runs likewise in its elongation. This results in a viewing window, which allows a visual check of the wires 3 held by the holding mechanisms 13, in the area of the upstream frame 27. Wire ends of the wires 3 protrude beyond the frame 27 of the holding device 6, with the result that the wire ends can be easily gripped by the wire handling device 4, not shown here for reasons of clarity.

To lock and release the wires 3, the holding mechanisms 13 in each case comprise a locking mechanism 14 in the form of a spring-actuated clamping mechanism. The wires 3 can be fixed relative to the holding device 6 and also freed again by means of the locking mechanisms 14.

To actuate the locking mechanisms 14, the wire processing device 1 comprises an actuation mechanism 26, connected to the control device 28 of the wire processing device 1, in the form of a release mechanism for the spring-actuated clamping mechanisms. The actuation mechanism 26 can be controlled by the control device 28, with the result that, corresponding to a program sequence running in an automated manner, a wire 3 to be processed in each case by the wire processing mechanism 2 can be freed by release of the respective locking mechanism 14, gripped by the wire handling device 4 and fed to the wire processing mechanism 2 for processing.

The holding device 6 comprises an encoder 11 in the form of an RFID chip, arranged on the underside of the holding device 6 and therefore not directly visible in FIG. 8, in which data about the wire population of the holding device 6 are stored. To read these data, the wire processing device 1 comprises an acquisition device 7 in the form of an RFID read head. The data read by the acquisition device 7 can be transmitted to the control device 28 of the wire processing device 1, with the result that this information can be incorporated in a wire processing process running in an automated manner.

### LIST OF REFERENCE NUMBERS

1 wire processing device
2 wire processing mechanism
3 wire
4 wire handling device
5 carrying device
6 holding device
7 acquisition device
8 guide device
9 connection device
10 locking device
11 encoder
12 connection mechanism
13 holding mechanism
14 locking mechanism
15 tube guide
16 wire store
17 tube
18 inner surface
19 wire processing system
20 storage device
21 terminal block
22 collection mechanism
23 storage floor
24 wheel
25 fixing device
26 actuation mechanism
27 frame
28 control device
B movement direction
L longitudinal extent

1. A wire processing device, in particular a wire finishing machine, comprising:
at least one wire processing mechanism for processing at least one wire,
at least one wire handling device for transferring the at least one wire to the at least one wire processing mechanism,
wherein the wire processing device has at least one carrying device, wherein at least one holding device for holding the at least one wire can be releasably arranged on the at least one carrying device, wherein the wire processing device comprises at least one acquisition device for acquiring data stored on the at least one holding device.

2. The wire processing device according to claim 1, wherein the at least one carrying device is arranged on the wire processing device movable relative to the wire handling device, preferably displaceable translationally back and forth along a movement direction.

3. The wire processing device according to claim 1, wherein the wire processing device comprises at least one guide device, wherein the at least one carrying device is mounted on the at least one guide device movable translationally along the at least one guide device.

4. The wire processing device according to claim 1, wherein the at least one carrying device has at least one connection device for connecting the at least one carrying device to the at least one holding device.

5. The wire processing device according to claim 1, wherein wire processing device comprises a locking device for locking the at least one holding device on the at least one carrying device and for releasing the at least one holding device from the at least one carrying device.

6. The wire processing device according to claim 1, wherein at least two holding devices can be arranged on the at least one carrying device, preferably one behind another along a longitudinal extent of the at least one carrying device.

7. The wire processing device according to claim 1, wherein the wire processing device comprises at least one holding device for holding the at least one wire, wherein the at least one holding device is releasably arranged on the at least one carrying device.

8. The wire processing device according to claim 1, wherein the at least one holding device comprises an encoder, wherein preferably data can be and/or are stored in the encoder.

9. The wire processing device according to claim 1, wherein the at least one holding device has at least one connection mechanism for connecting the at least one holding device to the carrying device.

10. The wire processing device according to claim 1, wherein the at least one holding device comprises at least one holding mechanism for holding the at least one wire.

11. The wire processing device according to claim 10, wherein the at least one holding mechanism comprises at least one locking mechanism for locking and releasing the at least one wire.

12. The wire processing device according to claim 10, wherein at least one tube guide is arranged between the at least one holding mechanism and at least one wire store, wherein the at least one holding mechanism is preferably connected to the at least one tube guide.

13. The wire processing device according to claim 12, wherein the at least one tube guide comprises a, preferably flexible, tube.

14. The wire processing device according to claim 13, wherein the tube has a friction-reducing coating, preferably a Teflon coating, on an inner surface of the tube.

15. A wire processing system comprising
the wire processing device according to claim 1,
at least one storage device comprising at least one wire store for providing at least one wire,
at least one holding device for holding the at least one wire,
wherein the at least one wire of the at least one wire store is guided to the at least one holding device and held by the at least one holding device, wherein the at least one holding device can be or is releasably arranged on the at least one carrying device of the wire processing device.

16. The wire processing system according to claim 15, wherein the at least one wire is guided between the wire store providing the at least one wire and the at least one holding device at least in sections inside a tube guide comprising a, preferably flexible, tube.

17. The wire processing system according to claim 15, wherein the at least one holding device comprises an encoder, wherein data can be and/or are stored in the encoder, wherein the wire processing device comprises at least one acquisition device for acquiring data stored in the encoder.

18. The wire processing system according to claim 1, wherein the at least one storage device is formed mobile.
